(19) United States
(12) Patent Application Publication
(10) Pub. No.: US 2019/0233242 A1
(43) Pub. Date: Aug. 1, 2019

(54) POST-PROCESSING APPARATUS, IMAGE FORMING APPARATUS, AND IMAGE FORMING SYSTEM

(71) Applicant: Konica Minolta, Inc., Tokyo (JP)

(72) Inventor: Hiroyuki WAKABAYASHI, Hachioji-shi, Tokyo (JP)

(21) Appl. No.: 16/241,480

(22) Filed: Jan. 7, 2019

(30) Foreign Application Priority Data
Jan. 31, 2018 (JP) 2018-014253

(51) Int. Cl. B65H 33/04; B65H 35/00; H04N 1/00

(52) U.S. Cl. CPC B65H 33/04; B65H 35/0006; H04N 1/00631; B65H 2513/51; B65H 2511/12; B65H 2511/411; H04N 1/00676

(57) ABSTRACT

A post-processing apparatus includes: a cutter that cuts a paper sheet into a plurality of pieces; and a hardware processor that causes the cutter to cut out a product formed in part of the paper sheet and a partition sheet formed in another part of the paper sheet, wherein the hardware processor causes the partition sheet and the product to be ejected to the same ejection destination at timings different from each other, and the partition sheet is formed between jobs that cause the product to be generated.

The entire disclosure of Japanese patent Application No. 2018-014253, filed on Jan. 31, 2018, is incorporated herein by reference in its entirety.

### BACKGROUND

### Technological Field

The present disclosure relates to a post-processing apparatus, an image forming apparatus, and an image forming system.

### Description of the Related Art

Conventionally, a post-processing apparatus is used that performs post-processing on a paper sheet on which an image has been formed by an image forming apparatus. The post-processing apparatus generates products, for example, by dividing and cutting a single paper sheet into plural pieces. Examples of the products include business cards, cards, postcards, and the like, and the products are generated for each job. Accordingly, if the products of each of the jobs are ejected with no change to the same position, there is a possibility that products of a plurality of jobs will be mixed. Therefore, in many cases, measures are taken by taking out products of each single job. The measures described above result in a reduction in the productivity of products, and therefore an apparatus has been proposed that separately inserts a partition sheet between the products of jobs (see, for example, JP 2009-067482 A and JP 04-112163 A). An apparatus has also been proposed that sticks, on each document, a tag on which a pressure-sensitive adhesive has been applied (see, for example, JP 11-180622 A and JP 3166677 B2). Further, an apparatus has also been proposed that cuts continuous paper into each unit of paper sheets and that stacks each of the units of paper sheets after moving each of the units of paper sheets in a direction orthogonal to an ejection direction at the time of ejection to an ejection destination (see, for example, JP 3626261 B2).

However, in the conventional techniques described in JP 2009-067482 A and JP 04-112163 A, switching processing is performed for switching the processing to a process that is different from a process of products in order to insert a partition sheet. Accordingly, the production of products is requested to be interrupted due to the switching processing, and this results in a reduction in the productivity of products. In addition, in the conventional techniques described in JP 11-180622 A and JP 3166677 B2, a process for sticking a tag is requested to be performed, and in the conventional technique described in JP 3626261 B2, a process for moving a cut unit of paper sheets in a direction orthogonal to an ejection direction is requested to be performed. Accordingly, even in the conventional techniques described in JP 11-180622 A, JP 3166677 B2, and JP 3626261 B2, the productivity of products is reduced.

### SUMMARY

The present disclosure has been made in view of the situations described above, and an object of the present disclosure is to maintain the productivity of products while the products of a plurality of jobs are avoided from being mixed.

To achieve the abovementioned object, according to an aspect of the present invention, a post-processing apparatus reflecting one aspect of the present invention comprises: a cutter that cuts a paper sheet into a plurality of pieces; and a hardware processor that causes the cutter to cut out a product formed in part of the paper sheet and a partition sheet formed in another part of the paper sheet, wherein the hardware processor causes the partition sheet and the product to be ejected to the same ejection destination at timings different from each other, and the partition sheet is formed between jobs that cause the product to be generated.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates an example of the entire configuration of an image forming system according to a first embodiment of the present disclosure;

FIG. 2 illustrates a principal part of a control system of the image forming system according to the first embodiment of the present disclosure;

FIGS. 3A and 3B illustrate examples of imposition according to the first embodiment of the present disclosure;

FIGS. 4A to 4H illustrate examples of the stacking of respective products and respective partition sheets that have been cutting out according to the first embodiment of the present disclosure;

FIG. 5 is a side view illustrating an example of a partition sheet stacked on products of a job according to the first embodiment of the present disclosure;

FIG. 6 is a top view illustrating an example of a partition sheet according to the first embodiment of the present disclosure;

FIG. 7 is a flowchart explaining an example of control according to the first embodiment of the present disclosure;

FIG. 8 is a side view illustrating an example of a partition sheet stacked on products of a job according to a second embodiment of the present disclosure;

FIGS. 9A and 9B illustrate an example of an image of a product and an example of an image of a partition sheet according to a third embodiment of the present disclosure;

FIGS. 10A and 10B are side views illustrating examples of a partition sheet stacked between the products of jobs according to a fourth embodiment of the present disclosure; and

FIG. 11 is a flowchart explaining an example of control according to a fifth embodiment of the present disclosure.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

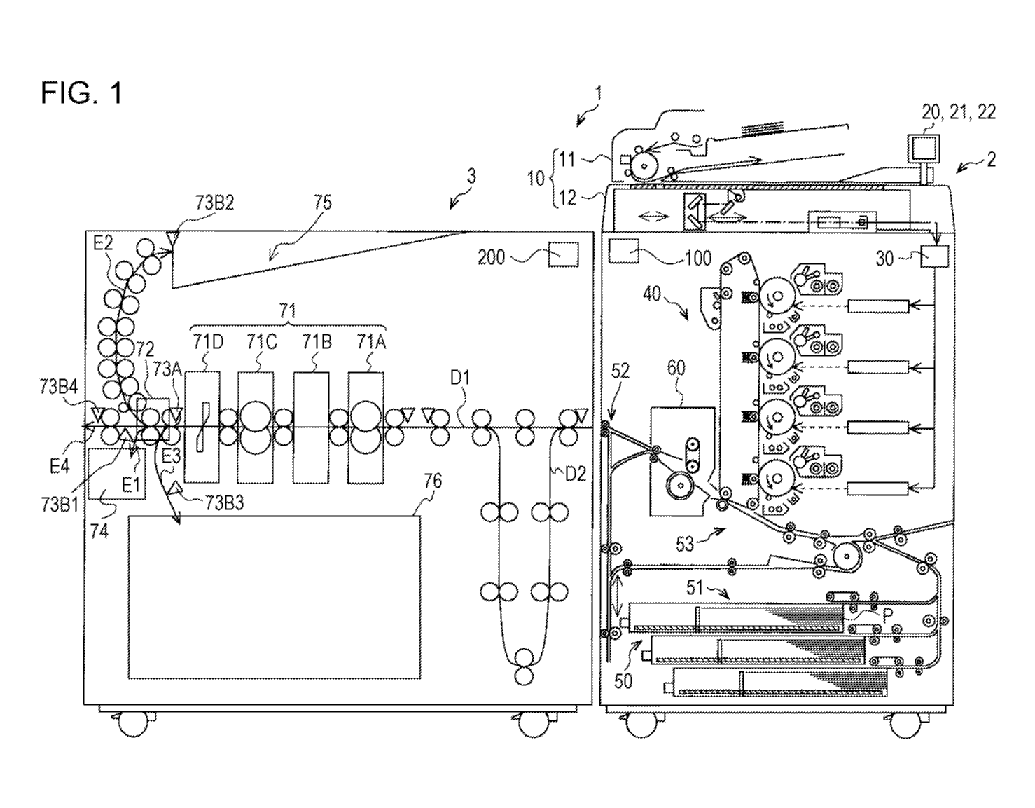

FIG. 1 illustrates an example of the entire configuration of an image forming system 1 according to a first embodiment of the present disclosure. As illustrated in FIG. 1, the image forming system 1 has a configuration in which a post-processing apparatus 3 is connected to a rear-stage side of an image forming apparatus 2. The post-processing apparatus 3 includes a cutter 71 and a controller 200, and performs various types of post-processing on a paper sheet P conveyed from the image forming apparatus 2. Details of the post-processing apparatus 3 will be described later. The image forming apparatus 2 is an apparatus that forms an intermediate transfer type color image by using an electrophotographic process technique. The image forming apparatus 2 employs a vertical tandem system in which photoreceptor drums, which correspond to four colors of Y, M, C, and K, are arranged in series in a traveling direction of an intermediate transfer belt, namely, in a vertical direction, and toner images of the respective colors are sequentially transferred to the intermediate transfer belt in a single procedure. Stated another way, the image forming apparatus 2 forms an image by primarily transferring, to the intermediate transfer belt, toner images of respective colors, Y (yellow), M (magenta), C (cyan), and K (black), that have been formed on the photoreceptor drums, superimposing the toner images of four colors onto each other on the intermediate transfer belt, and secondarily transferring the toner images to a paper sheet P.

The image forming apparatus 2 includes an image reader 10, an operation display 20, an image processing unit 30, an image former 40, a paper conveyor 50, a fixer 60, and a controller 100. The image reader 10 includes an automatic original feeder 11, an original image scanner 12, and the like. The automatic original feeder 11 is referred to as an auto document feeder (ADF). The automatic original feeder 11 conveys an original placed on an original tray by using a conveyance mechanism, and sends out the original to the original image scanner 12. The automatic original feeder 11 can continuously read the images of a large number of originals that have been placed on the original tray. When the automatic original feeder 11 continuously reads the images of the large number of originals, the automatic original feeder 11 can read both sides of each of the originals by using a paper reversing mechanism. The original image scanner 12 optically scans an original that has been conveyed from the automatic original feeder 11 onto a contact glass or an original that has been placed on the contact glass. The original image scanner 12 reads an original image formed in an original by forming an image of reflected light from the original that has been generated by performing optical scanning on a light receiving surface of a CCD sensor. The image reader 10 generates the input image data of the original image on the basis of a reading result of the original image scanner 12. The input image data is supplied to the image processing unit 30, and the image processing unit 30 performs image processing that has been set in advance.

The operation display 20 is implemented, for example, by a liquid crystal display (LCD) with a touch panel, and functions as a display 21 and an operation unit 22. The display 21 displays various operation screens, the state of an image, the operation situation of each function, and the like in accordance with a display control signal that has been input from the controller 100. The operation unit 22 includes various operation keys such as a numeric keypad or a start key. The operation unit 22 generates an operation signal by receiving various input operations performed by a user. The operation signal is output to the controller 100.

The image processing unit 30 includes a circuit that performs digital image processing according to initial settings or user settings on the input image data. The image processing unit 30 performs, for example, gradation correction on the input image data on the basis of a gradation correction table in which gradation correction data has been set under the control of the controller 100. The image processing unit 30 performs various types of correction processing, such as color correction or shading correction, in addition to gradation correction, compression processing, and the like on the input image data. The image former 40 performs various types of processing on the basis of the input image data on which the various types of digital image processing described above have been performed. The image former 40 forms images using respective colored toners of a Y-component, an M-component, a C-component, and a K-component on the basis of the input image data. The image former 40 includes photoreceptor drums, a charging device, an exposure device, a development device, and an intermediate transfer device. The surfaces of the photoreceptor drums are uniformly charged due to the corona discharge of the charging device. The exposure device irradiates the photoreceptor drums with laser beams that correspond to the images of respective color components, so that electrostatic latent images of the respective color components are formed on the surfaces of the photoreceptor drums. The development device makes toners of the respective color components supplied on the surfaces of the photoreceptor drums, so that the electrostatic latent images are visualized, and toner images are formed. The toner images are transferred onto the paper sheet P by the intermediate transfer device.

The fixer 60 fixes the toner images on the paper sheet P by heating and pressing the toner images transferred onto the paper sheet P. The paper conveyor 50 includes a paper feeder 51, a paper ejector 52, a conveyance path 53, and the like. Each type of paper sheet P that has been set in advance according to a basis weight, size, and the like is stored in the paper feeder 51. A paper sheet P stored in the paper feeder 51 or a paper sheet P in which an image has been formed on either a front side or a reverse side is conveyed along the conveyance path 53. The paper ejector 52 ejects a paper sheet P on which an image has been formed to the outside of a machine.

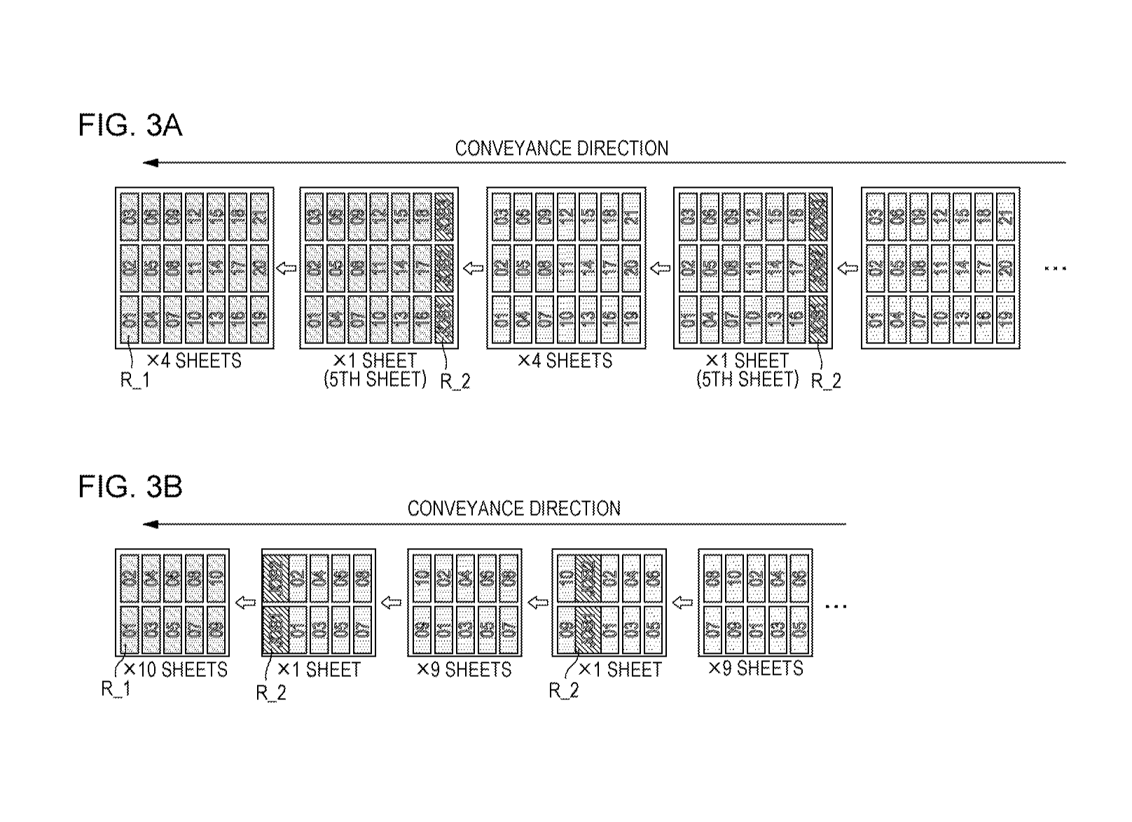

The post-processing apparatus 3 includes a conveyance path switching unit 72, a detection sensor 73A, an ejected paper sensor 73B1, an ejected paper sensor 73B2, an ejected paper sensor 73B3, an ejected paper sensor 73B4, a card tray 74, a purge tray 75, a waste box 76, a conveyance path D1, an ejected paper conveyance path E1, an ejected paper conveyance path E2, an ejected paper conveyance path E3, and an ejected paper conveyance path E4 in addition to the cutter 71 and the controller 200. A long-paper conveyance path D2 is provided in the conveyance path D1. The long-paper conveyance path D2 functions as a buffer when long paper is conveyed. A product R_1 or a partition sheet R_2 has been printed on a paper sheet P conveyed from the paper ejector 52 of the image forming apparatus 2 to the conveyance path D1, as illustrated in FIGS. 3A and 3B described later. The cutter 71 is arranged on a rear-stage side of the image forming apparatus 2 that forms the product R_1 and the partition sheet R_2, and cuts the paper sheet P into plural pieces. The controller 200 causes the cutter 71 to cut out a product R_1 formed in pan of the paper sheet P and a partition sheet R_2 formed in another part of the paper sheet P. The cutter 71 includes at least one of a post-processing module 71A, a post-processing module 71B, a post-processing module 71C, and a post-processing module 71D. Each of the post-processing modules 71A to 71D is configured to be attachable to or detachable from the post-processing apparatus 3, and the arrangement order of the post-processing modules 71A to 71D is also appropriately switchable. For example, at least one of the post-processing modules 71A to 71D can be detached from the post-processing apparatus 3 according to the product R_1.

The post-processing module 71A includes a slitter that cuts the paper sheet P in a conveyance direction, namely, a sub-scanning direction. Top and bottom margins are cut off, for example, as a first margin of the paper sheet P by the post-processing module 71A. In a case where the slitter of the post-processing module 71A cuts off the top and bottom margins, the slitter functions as a top and bottom slitter. The post-processing module 71B may include, for example, a creasing unit that creases the paper sheet P that has been cut by the post-processing module 71A. The post-processing module 71B may include a perforating unit that forms perforations in the paper sheet P that has been cut by the post-processing module 71A. In a case where the post-processing module 71B does not perform processing, such as creasing or perforating, on the paper sheet P, only a guide plate may be provided along the conveyance path D1. The post-processing module 71C includes a slitter that cuts the paper sheet P in the conveyance direction. A position where the slitter of the post-processing module 71C is arranged is different from a position where the slitter of the post-processing module 71A is arranged. A margin between the products R_1 or between the partition sheets R_2 is cut off, for example, as a second margin of the paper sheet P by the post-processing module 71C. In a case where the slitter of the post-processing module 71C cuts off the margin between the products R_1 or between the partition sheets R_2, the slitter functions as a bleeding-off slitter. The post-processing module 71D includes a guillotine cutter that cuts the paper sheet P that has been cut by the post-processing module 71C in a direction orthogonal to the conveyance direction, namely, in a principal scanning direction. The paper sheet P that has been cut in the principal scanning direction by the post-processing module 71D is conveyed as the products R_1, the partition sheets R_2, or chips to the rear. The cutting of the paper sheet P in parallel to the conveyance direction is referred to as feed direction (FD) cutting, and the cutting of the paper sheet P in the direction orthogonal to the conveyance direction is referred to as cross direction (CD) cutting. FD cutting is performed by the post-processing modules 71A and 71C, and CD cutting is performed by the post-processing module 71D.

The conveyance path switching unit 72 switches a conveyance path to any of the ejected paper conveyance paths E1 to E4 according to a conveyance destination of the paper sheet P that has passed through the cutter 71. The product R_1 or the partition sheet R_2 is conveyed to the card tray 74 along the ejected paper conveyance path E1. The product R_1 or the partition sheet R_2 is conveyed to the purge tray 75 along the ejected paper conveyance path E2. Chips are conveyed to the waste box 76 along the ejected paper conveyance path E3. The product R_1 or the partition sheet R_2 is conveyed along the ejected paper conveyance path E4 to another processing apparatus that is connected to a rear-stage side of the post-processing apparatus 3. The detection sensor 73A is provided between the post-processing module 71D and the conveyance path switching unit 72, and detects the product R_1 or the partition sheet R_2 that has been ejected from the post-processing module 71D. In a case where a preset time period has passed but the detection sensor 73A does not detect the product R_1 or the partition sheet R_2, the controller 200 determines that a jam has occurred in the conveyance path D1.

The card tray 74 is a paper ejection destination of the ejected paper conveyance path E1 to which the conveyance path switching unit 72 has switched the conveyance path, and the card tray 74 may be formed to have a size enough to store the product R_1 and the partition sheet R_2. The product R_1 and the partition sheet R_2 that have been conveyed along the ejected paper conveyance path E1 can be stacked on the card tray 74. The controller 200 performs control to convey the product R_1 and the partition sheet R_2 to the card tray 74 along the ejected paper conveyance path E1. The ejected paper sensor 73B1 is provided in the ejected paper conveyance path E1. Therefore, the controller 200 can detect whether a product R_1 or a partition sheet R_2 to be conveyed along the ejected paper conveyance path E1 has been certainly ejected to the card tray 74 on the basis of a detection result of the ejected paper sensor 73B1.

The purge tray 75 is a paper ejection destination of the ejected paper conveyance path E2 to which the conveyance path switching unit 72 has switched the conveyance path, and a sheet that has been cut out to have a size larger than the sizes of the product R_1 and the partition sheet R_2, in addition to the product R_1 and the partition sheet R_2, can also been stacked on the purge tray 75. The controller 200 performs control to convey the product R_1 and the partition sheet R_2 to the purge tray 75 along the ejected paper conveyance path E2. The ejected paper sensor 73B2 is provided in the ejected paper conveyance path E2. Therefore, the controller 200 can detect whether a product R_1 or a partition sheet R_2 to be conveyed along the ejected paper conveyance path E2 has been certainly ejected to the purge tray 75 on the basis of a detection result of the ejected paper sensor 73B2.

The waste box 76 is a paper ejection destination of the ejected paper conveyance path E3 to which the conveyance path switching unit 72 has switched the conveyance path. Chips, such as the first margin, the second margin, or the margin between the products R_1, that have been cut off by the cutter 71 are stored in the waste box 76. The controller 200 performs control to convey various chips that have been cut off by the cutter 71 to the waste box 76 along the ejected paper conveyance path E3. The ejected paper sensor 73B3 is provided in the ejected paper conveyance path E3. Therefore, the controller 200 can detect whether various chips to be conveyed along the ejected paper conveyance path E3 have been certainly ejected to the waste box 76 on the basis of a detection result of the ejected paper sensor 73B3. In a case where the waste box 76 is provided just blow the cutter 71, chips that have been cut off are directly dropped into the waste box 76, and therefore the ejected paper conveyance path E3 is not provided, and the ejected paper sensor 73B3 is also omitted.

In a case where a processing apparatus is connected to a rear-stage side of the post-processing apparatus 3, the product R_1 or the partition sheet R_2 is conveyed along the ejected paper conveyance path E4 to the processing apparatus serving as a paper ejection destination of the ejected paper conveyance path E4 to which the conveyance path switching unit 72 has switched the conveyance path. The ejected paper sensor 73B4 is provided in the ejected paper conveyance path E4. Therefore, the controller 200 can detect whether a product R_1 or a partition sheet R_2 to be conveyed along the ejected paper conveyance path E4 has been certainly ejected to the processing apparatus on the basis of a detection result of the ejected paper sensor 73B4.

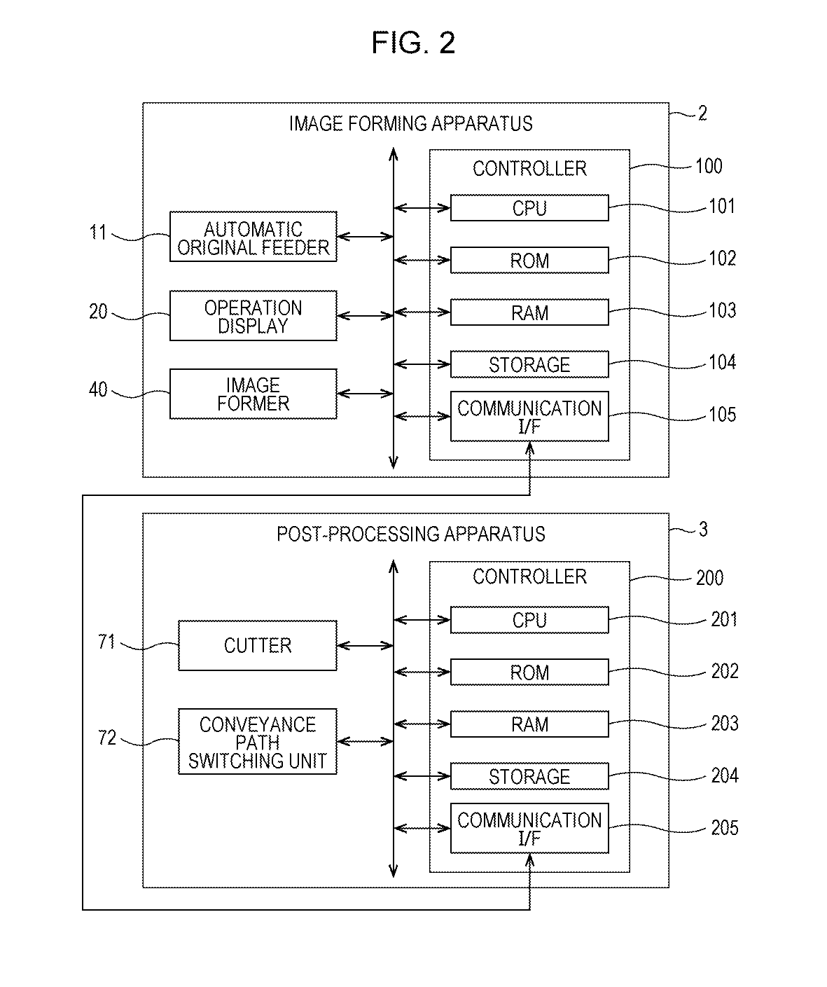

FIG. 2 illustrates a principal part of a control system of the image forming system 1 according to the first embodiment of the present disclosure. As illustrated in FIG. 2, the controller 100 of the image forming apparatus 2 includes a CPU 101, a ROM 102, a RAM 103, a storage 104, and a communication interface 105. The automatic original feeder 11, the operation display 20, the image former 40, and the controller 100 in the image forming apparatus 2 are connected via a bus. The CPU 101 is used as an example of a processor that controls the operations of the automatic original feeder 11, the operation display 20, the image former 40, and the like in the image forming apparatus 2. For example, the CPU 101 controls the image formation processing of the image former 40 on the basis of a printing instruction of a user that has been issued via the operation display 20. The ROM 102 is used as an example of a non-volatile memory, and stores a program that is used for the CPU 101 to operate, data, or the like. The RAM 103 is used as an example of a non-volatile memory, and temporarily stores data for various types of processing performed by the CPU 101. The storage 104 is configured, for example, by a hard disk drive (HDD), and stores a program that causes the CPU 101 to control the image forming apparatus 2, an operating system (OS), and data. Part of the program and the data that are stored in the storage 104 is also stored in the ROM 102. The storage 104 is used as an example of a non-transitory computer-readable recording medium that stores a program executed by the CPU 101. The storage 104 is not limited to the HDD, and may be, for example, a recording medium such as a solid state drive (SSD) or a Blu-ray Disc (registered trademark). The communication interface 105 is configured by a network interface card (NIC), a modem, or the like, establishes connection with the post-processing apparatus 3, a not-illustrated external terminal, and the like, and performs the transmission or reception of various types of data.

In addition, the controller 200 of the post-processing apparatus 3 includes a CPU 201, a ROM 202, a RAM 203, a storage 204, and a communication interface 205, as illustrated in FIG. 2. The cutter 71, the conveyance path switching unit 72, and the controller 200 in the post-processing apparatus 3 are connected via a bus. The CPU 201 is used as an example of a processor that controls the operations of the cutter 71, the conveyance path switching unit 72, and the like in the post-processing apparatus 3. For example, the CPU 201 has a function of executing cutting processing performed by the cutter 71, processing for switching the ejected paper conveyance paths E1 to E4 of the cut paper sheet P, and the like. The ROM 202 is used as an example of a non-volatile memory, and stores a program that is used for the CPU 201 to operate, data, or the like. The RAM 203 is used as an example of a non-volatile memory, and temporarily stores data for various types of processing performed by the CPU 201. The storage 204 is configured, for example, by an HDD, and stores a program that causes the CPU 201 to control the post-processing apparatus 3, an OS, and data. Part of the program and the data that are stored in the storage 204 is also stored in the ROM 202. The storage 204 is used as an example of a non-transitory computer-readable recording medium that stores a program executed by the CPU 201. The storage 204 is not limited to the HDD, and may be, for example, a recording medium such as an SSD or a Blu-ray Disc. The communication interface 205 is configured by an NIC, a modem, or the like, establishes connection with the image forming apparatus 2, a not-illustrated external terminal, and the like, and performs the transmission or reception of various types of data. If the post-processing apparatus 3 is provided in-line in the image forming apparatus 2, various functions executed by the post-processing apparatus 3 may be executed by using the CPU 101, the ROM 102, the RAM 103, and the storage 104 of the image forming apparatus 2. Accordingly, a configuration obtained by excluding the CPU 201, the ROM 202, the RAM 203, and the storage 204 from the post-processing apparatus 3 may be employed.

FIGS. 3A and 3B illustrate examples of imposition according to the first embodiment of the present disclosure. FIG. 3A illustrates an example of imposition in a case where 102 business cards are generated, for example, in a paper sheet P of A3 wide formal. FIG. 3B illustrates an example of imposition in a case where 100 business cards are generated, for example, in a paper sheet P of A4 format. FIGS. 3A and 3B explain an example in which business cards are generated, but the present disclosure is not particularly limited to this. For example, cards, postcards, or the like may be generated. In the examples illustrated in FIGS. 3A and 3B, a partition sheet R_2 has a length in a direction orthogonal to the conveyance direction of the paper sheet P that is equal to a length of a product R_1, and has a length in the conveyance direction of the paper sheet P that is longer than a length of the product R_1. The products R_1 have the same size as each other, and therefore the products R_1 also have the same length in the conveyance direction of the paper sheet P as each other. Accordingly, by matching a conveyance timing of the paper sheet P with a CD cutting timing of the product R_1, the CD cutting of the product R_1 can be performed at a constant speed. In contrast, a length in the conveyance direction of the paper sheet P of the partition sheet R_2 is different from a length of the product R_1, and therefore it is requested to control the CD cutting timing of the partition sheet R_2 so as to be different from the CD cutting timing of the product R_1. Stated another way, in a case where the size of the partition sheet R_2 is different from the size of the product R_1 and CD cutting is performed on the partition sheet R_2, the controller 200 matches the conveyance timing of the paper sheet P with the cutting timing of the partition sheet R_2. In addition, the partition sheet R_2 is formed between jobs that cause the products R_1 to be generated. Therefore, in a case where a single job is processed, a plurality of products R_1 are continuously formed in a paper sheet P, and a partition sheet R_2 is formed between the single job and the next job. Accordingly, in the example of FIG. 3A. 102 business cards are ejected as the products R_1, and partition sheets R_2 are ejected to the same ejection destination as an ejection destination of the products R_1. Stated another way, the controller 200 causes the partition sheets R_2 and the products R_1 to be ejected to the same ejection destination at different timings. In the example of FIG. 3A, products R_1 that have been formed in three rows in the direction orthogonal to the conveyance direction of the paper sheet P are stacked, and therefore a partition sheet R_2 is stacked after 34 products R_1 are ejected, and the stacking of products R_1 that corresponds to the next job is started. Stated another way, in the example of FIG. 3A, from among 105 pieces into which the paper sheet P has been divided and cut, a final piece of each job is the partition sheet R_2. In FIG. 3B, a configuration in which the partition sheet R_2 is stacked in a position of a division between jobs is employed similarly to FIG. 3A.

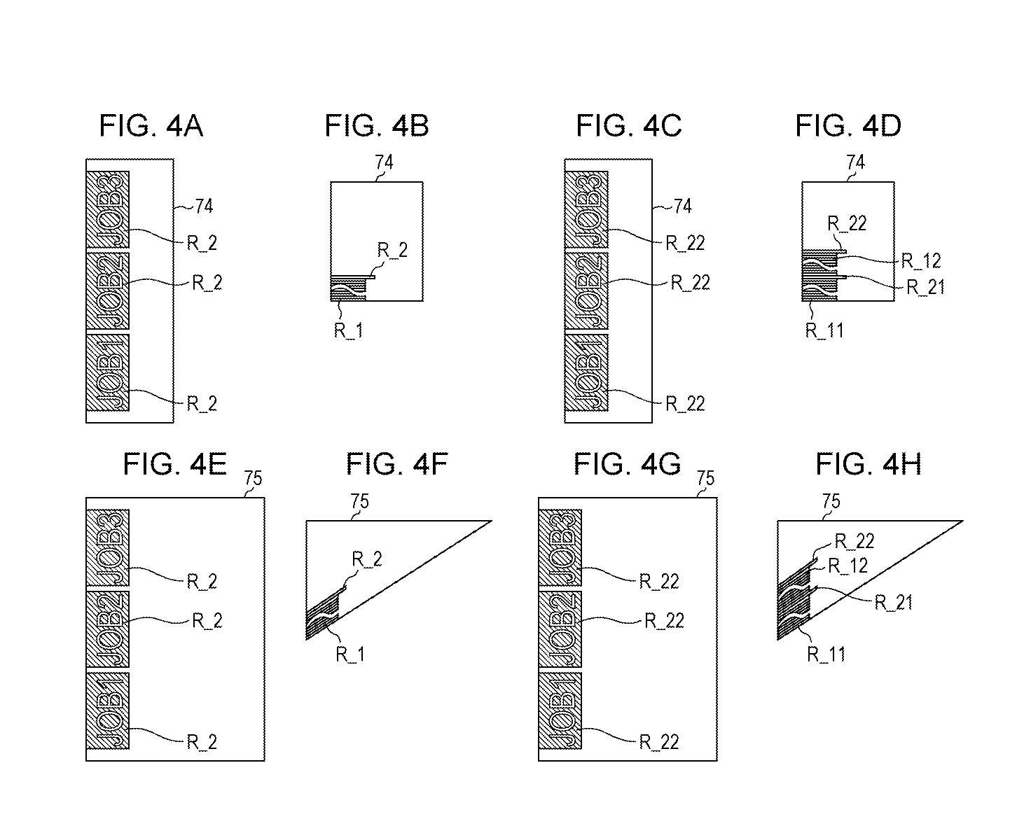

FIGS. 4A to 4H illustrate examples of the stacking of respective products R_1 and respective partition sheets R_2 that have been cutting out according to the first embodiment of the present disclosure. FIG. 4A is a top view illustrating an example in which partition sheets R_2 are stacked on three rows of 34 products R_1 that have been stacked on the card tray 74. FIG. 4B is a side view illustrating an example in which partition sheets R_2 are stacked on three rows of 34 products R_1 that have been stacked on the card tray 74. FIG. 4C is a top view illustrating an example in which partition sheets R_2 are stacked on three rows of 34 products R_1 that have been stacked on the card tray 74 and products and partition sheets for the next jobs are further stacked. FIG. 4D is a side view illustrating an example in which partition sheets R_21 are stacked on three rows of 34 products R_11 that have been stacked on the card tray 74 and products and partition sheets for the next jobs are further stacked. As illustrated in FIGS. 4C and 4D, the products R_11 and the partition sheet R_21 form a single set, and products R_12 and a partition sheet R_22 form another single set.

FIG. 4E is a lop view illustrating an example in which partition sheets R_2 are stacked on three rows of 34 products R_1 that have been stacked on the purge tray 75. FIG. 4F is a side view illustrating an example in which partition sheets R_2 are stacked on three rows of 34 products R_1 that have been stacked on the purge tray 75. FIG. 4G is a top view illustrating an example in which partition sheets R_2 are stacked on three rows of 34 products R_1 that have been stacked on the purge tray 75 and products and partition sheets for the next jobs are further stacked. FIG. 4H is a side view illustrating an example in which partition sheets R_21 are stacked on three rows of 34 products R_11 that have been stacked on the purge tray 75 and products and partition sheets for the next jobs are further stacked. In FIGS. 4G and 4H, similarly to FIGS. 4C and 4D, the products R_11 and the partition sheet R_21 form a single set, and products R_12 and a partition sheet R_22 form another single set. The product R_11 and the product R_12 are collectively referred to as a product R_1. The partition sheet R_21 and the partition sheet R_22 are collectively referred to as a partition sheet R_2.

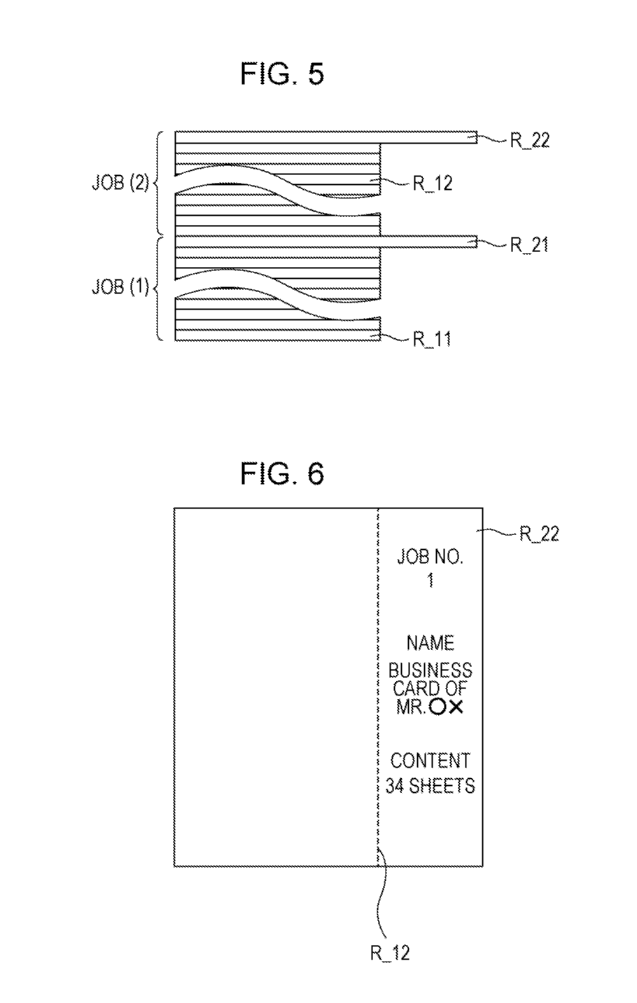

As illustrated in FIGS. 4A to 4H, in a case where the controller 200 causes either the partition sheet R_2 or the product R_1 to be ejected, the controller 200 causes the partition sheet R_2 or the product R_1 to be stacked in such a way that a front-end side of the partition sheet R_2 is aligned with a front-end side of the product R_1. Stated another way, when the controller 200 causes either the partition sheet R_2 or the product R_1 to be ejected to the same ejection destination, the controller 200 may adjust the ejection speeds of the partition sheet R_2 and the product R_1 in the card tray 74 in such a way that the partition sheet R_2 and the product R_1 that have been ejected collide against a downstream-side wall surface in the conveyance direction of the paper sheet P and drop to a bottom. The controller 200 may adjust the ejection speeds of the partition sheet R_2 and the product R_1 in the purge tray 75 in such a way that the partition sheet R_2 and the product R_1 that have been ejected are ejected onto an inclined surface of the purge tray 75 and slide down along the inclined surface of the purge tray 75 to a wall surface erected from a corner of the inclined surface of the purge tray 75. In all of FIGS. 4A to 4H, the partition sheet R_2 has a length in the conveyance direction of the paper sheet P that is longer than a length of the product R_1. Therefore, by stacking the partition sheet R_2 or the product R_1 in such a way that the front-end side of the partition sheet R_2 is aligned with the front-end side of the product R_1, the partition sheet R_2 is stacked in such a way that a rear-end side of the partition sheet R_2 projects outward beyond the product R_. FIG. 5 is a side view illustrating an example of a partition sheet R_2 stacked on products R_1 of a job according to the first embodiment of the present disclosure. As illustrated in FIG. 5, a rear-end side of a partition sheet R_21 projects outward beyond products R_11. This is similarly applied to the partition sheet R_22. Accordingly, when information specifying a jog is clearly indicted on a rear-end side of the partition sheet R_2, a user can intuitively distinguish products R_1 of a job from products R_1 of another job, and this results in improvements in the workability of the user.

FIG. 6 is a top view illustrating an example of a partition sheet R_2 according to the first embodiment of the present disclosure. In the example of FIG. 6, the indication “job no. ‘1’” is formed as an index that uniquely specifies a job that causes products R_1 to be generated on a rear-end side of the partition sheet R_2. The indication is not limited to the job number, and any index that uniquely specifies the job that causes products R_1 to be generated may be used. The indication may be, for example, an alphabet, a sign, a picture, an icon, or the like. In addition, the indication “business card of Mr. ∘×” is further formed as the name of the job that causes products R_1 to be generated on the rear-end side of the partition sheet R_2. Furthermore, the indication “34 sheets” is further formed as the processing content of the job that causes products R_1 to be generated on the rear-end side of the partition sheet R_2. As described above, by forming information that specifies a job on the rear-end side of the partition sheet R_2, the workability of a user can be improved.

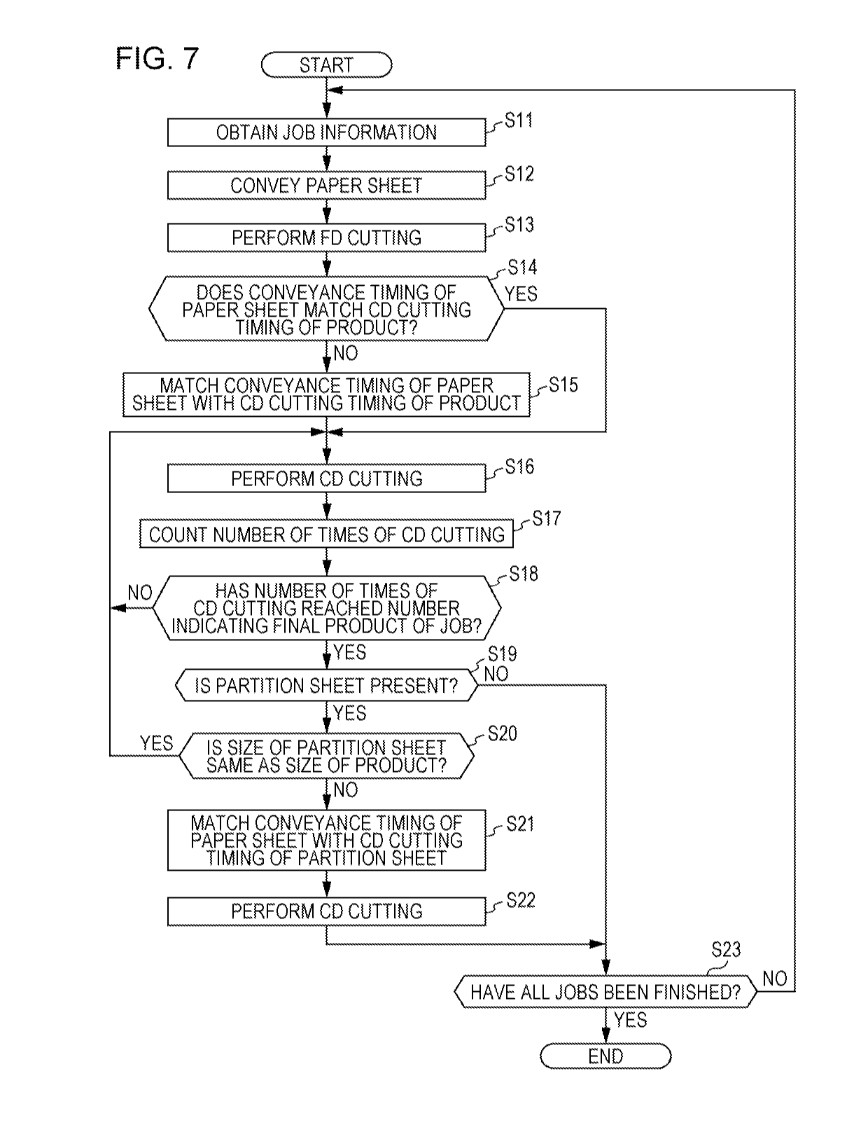

FIG. 7 is a flowchart explaining an example of control according to the first embodiment of the present disclosure. In step S11, the controller 200 obtains job information. The job information is information used to form a product R_1 and a partition sheet R_2, such as the number of products R_1 of a job, an imposition position of the products R_1, an imposition position of the partition sheet R_2, or the type of a paper sheet P. In step S12, the paper sheet P is conveyed along the conveyance path D1. When the job information is obtained in step S11, in a case where it is determined that a paper sheet P to be conveyed is long paper, the paper sheet P is conveyed along the long-paper conveyance path D2. In step S13, the post-processing module 71A and the post-processing module 71C perform FD cutting on the paper sheet P. In step S14, the controller 200 determines whether a conveyance timing of the paper sheet P matches a CD cutting timing of the product R_1. In a case where the controller 200 determines that the conveyance timing of the paper sheet P matches the CD cutting timing of the product R_1 (step S14; Y), the processing moves on to the process of step S16. In a case where the controller 200 determines that the conveyance timing of the paper sheet P does not match the CD cutting timing of the product R_1 (step S14; N), the processing moves on to the process of step S15. In step S15, the controller 200 matches the conveyance timing of the paper sheet P with the CD cutting timing of the product R_1.

In step S16, the post-processing module 71D performs CD cutting on the paper sheet P. In step S17, the controller 200 counts the number of times of CD cutting. In step S18, the controller 200 determines whether the number of times of CD cutting has reached a number indicating a final product R_1 of the job. In a case where the controller 200 determines that the number of times of CD cutting has reached the number indicating the final product R_1 of the job (step S18; Y), the processing moves on to the process of step S19. In a case where the controller 200 determines that the number of times of CD cutting has not reached the number indicating the final product R_1 of the job (step S18; N), the processing returns to the process of step S16. In step S19, the controller 200 determines whether a partition sheet R_2 is present. In a case where the controller 200 determines that the partition sheet R_2 is present (step S19; Y), the processing moves on to the process of step S20. In a case where the controller 200 determines that the partition sheet R_2 is absent (step S19; N), the processing moves on to the process of step S23. In step S20, the controller 200 determines whether the size of the partition sheet R_2 is the same as the size of the product R_1. In a case where the controller 200 determines that the size of the partition sheet R_2 is the same as the size of the product R_1 (step S20; Y), the processing returns to the process of step S16. In a case where the controller 200 determines that the size of the partition sheet R_2 is not the same as the size of the product R_1 (step S20; N), the processing moves on to the process of step S21. In step S21, the controller 200 matches the conveyance timing of the paper sheet P with the CD cutting timing of the partition sheet R_2. In step S22, the post-processing module 71D performs CD cutting on the paper sheet P. In step S23, the controller 200 determines whether all of the jobs have been finished. In a case where the controller 200 determines that all of the jobs have been finished (step S23; Y), the processing is terminated. In a case where the controller 200 determines that not all of the jobs have been finished (step S23; N), the processing returns to the process of step S11.

As described above, according to the present embodiment, the controller 200 causes the cutter 71 to cut out products R_1 formed in part of a paper sheet P and a partition sheet R_2 formed in another part of the paper sheet P. The controller 200 causes the partition sheet R_2 and the products R_1 to be ejected to the same ejection destination at different timings. The partition sheet R_2 is formed between jobs that cause the products R_1 to be generated. Therefore, the partition sheet R_2 can be cut out in the same CD cutting process as a CD cutting process of the products R_1, and the processing is not switched to a separate process dedicated to the partition sheet R_2. In addition, the partition sheet R_2 is formed between jobs, and therefore the products R_1 can be divided for each of the jobs. Accordingly, the productivity of the products R_1 can be maintained while the products R_1 of a plurality of jobs can be avoided from being mixed.

In addition, according to the present embodiment, in a case where the size of the partition sheet R_2 is different from the size of the product R_1 and CD cutting is performed on the partition sheet R_2, the controller 200 matches the conveyance timing of the paper sheet P with the cutting timing of the partition sheet R_2. Therefore, the partition sheet R_2 can be cut out by only adjusting the cutting timing. Accordingly, the cutter 71 does not need to be set in an idle state before switching to the next job.

Further, according to the present embodiment, the partition sheet R_2 has a length in a direction orthogonal to the conveyance direction of the paper sheet P that is equal to a length of the product R_1, and has a length in the conveyance direction of the paper sheet P that is longer than a length of the product R_1. Therefore, while the partition sheet R_2 can be formed to have a size that is suitable for a paper ejection destination, the products R_1 of a plurality of jobs can be partitioned from each other by the partition sheet R_2.

Furthermore, according to the present embodiment, in a case where the controller 200 causes either the partition sheet R_2 or the product R_1 to be ejected, the controller 200 causes the partition sheet R_2 or the product R_1 to be slacked in such a way that a front-end side of the partition sheet R_2 is aligned with a front-end side of the product R_1. Therefore, the partition sheet R_2 and the product R_1 can be aligned with each other on the front-end side, and this results in improvements in the workability of division for each job.

Furthermore, according to the present embodiment, an index that uniquely specifies a job that causes products R_1 to be generated is formed on a rear-end side of the partition sheet R_2. Therefore, information used for a user to divide products R_1 for each job is formed, and this results in improvements in workability after the extraction of the products R_1.

Furthermore, according to the present embodiment, the name of a job that causes products R_1 to be generated is formed on the rear-end side of the partition sheet R_2. Therefore, a user can concretely specify the products R_1, and this results in improvements in workability at the time of classifying the products R_1.

Furthermore, according to the present embodiment, the processing content of a job that causes products R_1 to be generated is formed on the rear-end side of the partition sheet R_2. Therefore, a user can obtain information used to classify products R_1 for each job, and this results in improvements in workability at the time of organizing the products R_1.

Furthermore, according to the present embodiment, the cutter 71 is arranged on a rear-stage side of the image forming apparatus 2 that forms the product R_1 and the partition sheet R_2. Therefore, the product R_1 and the partition sheet R_2 that have been formed by the image forming apparatus 2 can be conveyed with no change and can be shifted to cutting processing, and this results in improvements in productivity.

### Second Embodiment

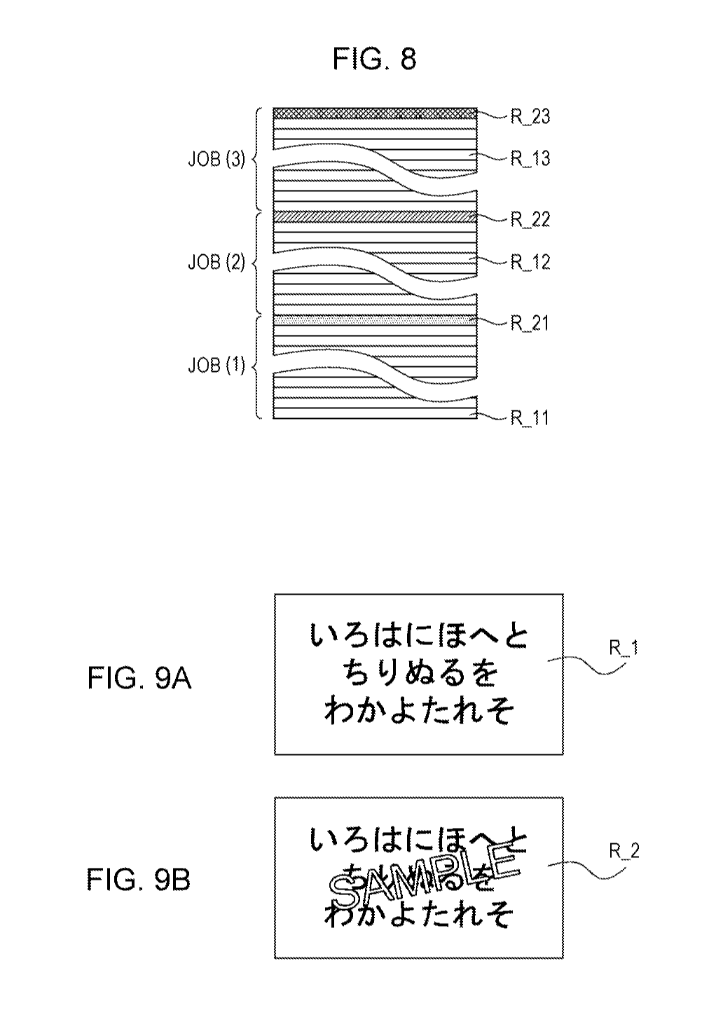

In a second embodiment, the description of configurations and functions that are similar to configurations and functions according to the first embodiment is omitted. The second embodiment is different from the first embodiment in the configuration of a partition sheet R_2. FIG. 8 is a side view illustrating an example of a partition sheet R_2 stacked on products R_1 of a job according to the second embodiment of the present disclosure. As illustrated in FIG. 8, products R_11 and a partition sheet R_21 are formed and stacked in job (1), products R_12 and a partition sheet R_22 are formed and stacked in job (2), and products R_13 and a partition sheet R_23 are formed and stacked in job (3). Therefore, the partition sheet R_21 is stacked in a division between job (1) and job (2), and the partition sheet R_22 is stacked in a division between job (2) and job (3). The partition sheet R_23 formed in job (3) is also stacked on the products R_13, and therefore a division between job (3) and the next job is clarified. The partition sheet R_21 to the partition sheet R_23 described above have the same size as the size of the product R_11 to the product R_13, but have colors that are different from each other. Therefore, a user can clearly and intuitively distinguish job (1) to job (3) from each other according to color. In addition, the product R_11 to the product R_13 have the same size as the size of the partition sheet R_21 to the partition sheet R_23, and therefore CD cutting can be performed on the partition sheet R_21 to the partition sheet R_23 at the same timing as a timing at which CD cutting is performed on the product R_11 to the product R_13. The partition sheet R_21 to the partition sheet R_23 are collectively referred to as a partition sheet R_2. In addition, the product R_1 to the product R_13 are collectively referred to as a product R_1.

As described above, according to the present embodiment, a partition sheet R_2 is formed in a color that is different for each job that causes products R_1 to be generated. Therefore, a user can clearly and intuitively distinguish jobs from each other according to color.

### Third Embodiment

In a third embodiment, the description of configurations and functions that are similar to configurations and functions according to the first and second embodiments is omitted. The third embodiment is different from the first and second embodiments in the configuration of a partition sheet R_2. FIGS. 9A and 9B illustrate an example of an image of a product R_1 and an example of an image of a partition sheet R_2 according to the third embodiment of the present disclosure. FIG. 9A illustrates an example of an image formed in the product R_1. FIG. 9B illustrates an example of an image formed in the partition sheet R_2. In the example of FIG. 9B, by additionally printing characters on the image formed in the product R_1, an image that is different from the image formed in the product R_1 is formed in the partition sheet R_2.

As described above, according to the present embodiment, an image that is different from an image in the product R_1 is formed in the partition sheet R_2. Therefore, a difference in an image enables a user to recognize the partition sheet R_2, and jobs can be easily partitioned.

### Fourth Embodiment

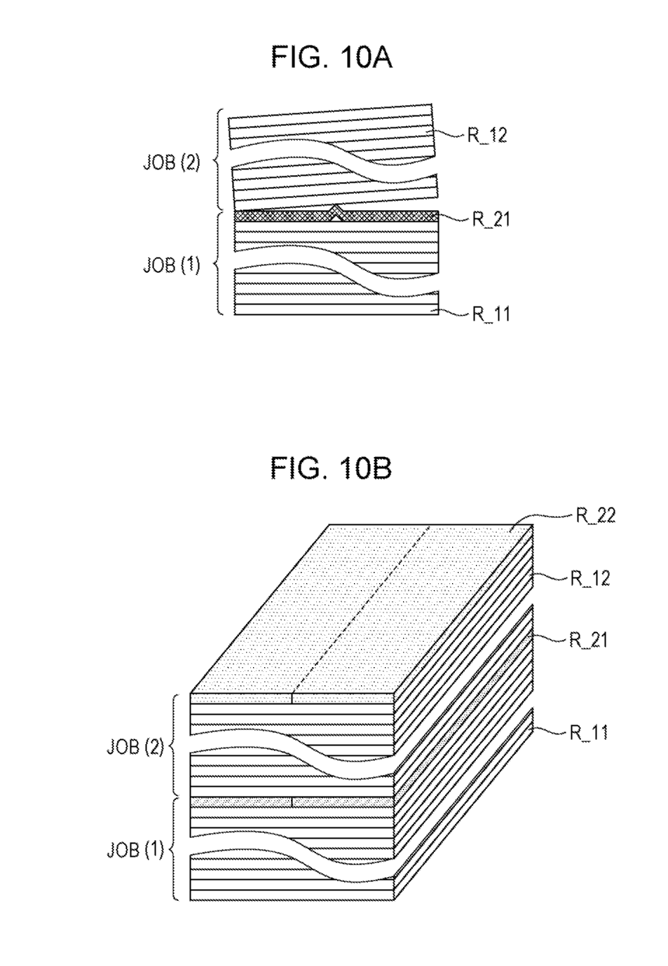

In a fourth embodiment, the description of configurations and functions that are similar to configurations and functions according to the first to third embodiments is omitted. The fourth embodiment is different from the first to third embodiments in the configuration of a partition sheet R_2. FIGS. 10A and 10B are side views illustrating examples of the partition sheet R_2 stacked between products R_1 of jobs according to the fourth embodiment of the present disclosure. In the example of FIG. 10A, processing that is different from processing performed on products R_11 of job (1) and products R_12 of job (2), such as creasing, is performed on a partition sheet R_21 stacked between the products R_11 and the products R_12. Therefore, the products R_11 and the products R_12 are easily distinguished from each other. In the example of FIG. 10B, as the processing that is different from the processing performed on the products R_11 and the products R_12, perforations are formed in a partition sheet R_21 and a partition sheet R_22. Similarly in the configuration described above, the products R_11 and the products R_12 are easily distinguished from each other.

As described above, according to the present embodiment, processing that is different from processing performed on the product R_1 is performed on the partition sheet R_2. Therefore, a processing form of the partition sheet R_2 enables a division between jobs to be easily identified.

In addition, according to the present embodiment, as the processing that is different from the processing performed on the product R_1, creasing is performed on the partition sheet R_2. This enables a division between jobs to be identified, in particular, remarkably and easily.

Further, according to the present embodiment, as the processing that is different from the processing performed on the product R_1, perforations are formed in the partition sheet R_2. This enables a division between jobs to be identified, in particular, remarkably and easily.

### Fifth Embodiment

In a fifth embodiment, the description of configurations and functions that are similar to configurations and functions according to the firth to fourth embodiments is omitted. In the fifth embodiment, the detailed configuration of the image forming apparatus 2 is described. The image former 40 included in the image forming apparatus 2 forms an image of a product R_1 in part of a paper sheet P, and forms a partition sheet R_2 in another part of the paper sheet P. In a case where the partition sheet R_2 is made plain, the image former 40 secures a range in which the partition sheet R_2 will be formed in accordance with the size of the partition sheet R_2. For example, as described with reference to FIGS. 3A and 3B, when no images are formed on the partition sheet R_2 in order to impose the partition sheet R_2 between jobs, a range for imposition may be secured. The partition sheet R_2 is used to distinguish products R_1 of a plurality of jobs from each other. Therefore, the image former 40 determines a position of a division between jobs that cause an image of the product R_1 to be formed as a position in which the partition sheet R_2 will be imposed. The image former 40 imposes a position in which the image of the product R_1 will be formed in accordance with the position in which the partition sheet R_2 will be imposed. In a case where a plurality of jobs that cause the image of the product R_1 to be formed are continuously processed, the image former 40 may form the partition sheet R_2, and in a case where a plurality of jobs that cause the image of the product R_1 to be formed are not continuously processed, namely, in a case where a single job is processed, the image former 40 does not need to form the partition sheet R_2.

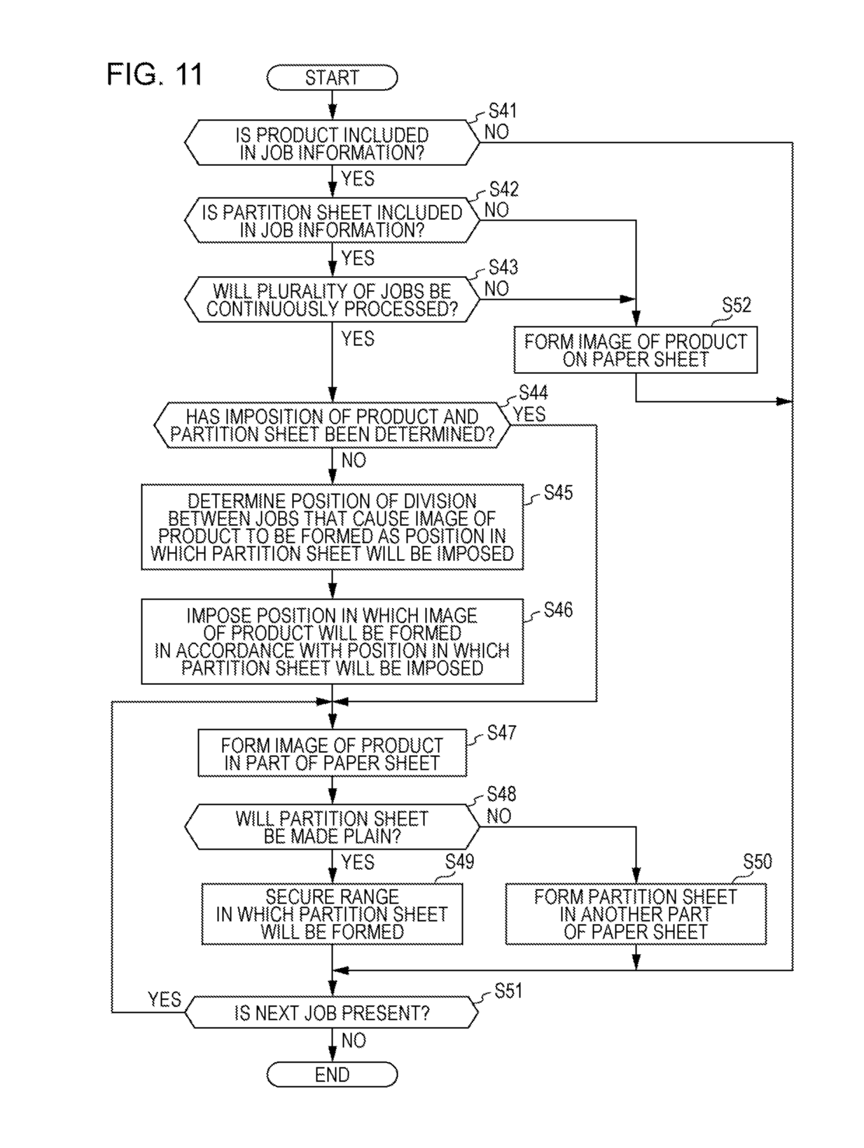

FIG. 11 is a flowchart explaining an example of control according to the fifth embodiment of the present disclosure. In step S41, the controller 100 determines whether a product R_1 is included in job information. In a case where the controller 100 determines that the product R_1 is included in the job information (step S41; Y), the processing moves on to the process of step S42. In a case where the controller 100 determines that the product R_1 is not included in the job information (step S41; N), the processing of the controller 100 moves on to the process of step S51. In step S42, the controller 100 determines whether a partition sheet R_2 is included in the job information. In a case where the controller 100 determines that the partition sheet R_2 is included in the job information (step S42; Y), the processing moves on to the process of step S43. In a case where the controller 100 determines that the partition sheet R_2 is not included in the job information (step S42; N), the processing moves on to the process of step S52. In step S43, the controller 100 determines whether a plurality of jobs will be continuously processed. In a case where the controller 100 determines that a plurality of jobs will be continuously processed (step S43; Y), the processing moves on to the process of step S44. In a case where the controller 100 determines that a plurality of jobs will not be continuously processed (step S43; N), the processing moves on to the process of step S52. In step S52, the image former 40 forms an image of the product R_1 on a paper sheet P, and the processing of the controller 100 moves on to the process of step S51.

In step S44, the controller 100 determines whether the imposition of the product R_1 and the partition sheet R_2 has been determined. In a case where the controller 100 determines that the imposition of the product R_1 and the partition sheet R_2 has been determined (step S44; Y), the processing moves on to the process of step S47. In a case where the controller 100 determines that the imposition of the product R_1 and the partition sheet R_2 has not been determined (step S44; N), the processing moves on to the process of step S45. In step 45, the controller 100 determines a position of a division between jobs that cause the image of the product R_1 to be formed as a position in which the partition sheet R_2 will be imposed. In step S46, the controller 100 imposes a position in which the image of the product R_1 will be formed in accordance with the position in which the partition sheet R_2 will be imposed.

In step S47, the image former 40 forms the image of the product R_1 in part of the paper sheet P. In step S48, the controller 100 determines whether the partition sheet R_2 will be made plain. In a case where the controller 100 determines that the partition sheet R_2 will be made plain (step S48; Y), the processing moves on to the process of step 49. In a case where the controller 100 determines that the partition sheet R_2 will not be made plain (step S48; N), the processing moves on to the process of step S50. In step S49, the image former 40 secures a range in which the partition sheet R_2 will be formed, and the processing moves on to the process of step S51. In step S50, the image former 40 forms the partition sheet R_2 in another part of the paper sheet P, and the processing moves on to the process of step S11. In step S11, the controller 100 determines whether the next job is present. In a case where the controller 100 determines that the next job is present (step S51; Y), the processing returns to the process of step S47. In a case where the controller 100 determines that the next job is absent (step S51; N), processing for forming the product R_1 and the partition sheet R_2 is terminated.

As described above, according to the present embodiment, the image forming apparatus 2 includes the image former 40 that forms an image of a product R_1 in part of a paper sheet P and that forms a partition sheet R_2 in another part of the paper sheet P. In a case where the partition sheet R_2 is made plain, the image former 40 secures a range in which the partition sheet R_2 will be formed in accordance with the size of the partition sheet R_2, and the partition sheet R_2 is formed between jobs that cause the product R_1 to be generated. Therefore, the partition sheet R_2 can be formed in a process for forming an image on the paper sheet P. In addition, in a case where the partition sheet R_2 is made plain, a range in which the partition sheet R_2 is expected to occupy in a case where the partition sheet R_2 is formed on the paper sheet P may be secured, and therefore a partition sheet P having a size suitable for a paper ejection destination can be easily formed.

Further, according to the present embodiment, the image former 40 imposes a position in which the image of the product R_1 will be formed in accordance with the position in which the partition sheet R_2 will be imposed. This enables imposition that does not reduce productivity when the post-processing apparatus 3 that is arranged on a post-stage side of the image forming apparatus 2 performs CD cutting.

Furthermore, according to the present embodiment, the image former 40 determines a position of a division between jobs that cause an image of the product R_1 to be formed as a position in which the partition sheet R_2 will be imposed. Therefore, the partition sheet R_2 can be reliably inserted between the jobs, and the workability of a user can be improved.

Furthermore, according to the present embodiment, in a case where a plurality of jobs that cause the image of the product R_1 to be formed are continuously processed, the image former 40 forms the partition sheet R_2. Therefore, the partition sheet R_2 enables the products R_1 of the plurality of jobs to be distinguished from each other without mixing the products R_1 of the plurality of jobs.

Furthermore, according to the present embodiment, the image forming system 1 includes the image former 40 that forms an image of the product R_1 in part of the paper sheet P and that forms the partition sheet R_2 in another part of the paper sheet P, a cutter 71 that cuts the paper sheet P into plural pieces, and the controller 200 that causes the cuter 71 to cut out the product R_1 and the partition sheet R_2. The controller 200 causes the partition sheet R_2 and the product R_1 to be ejected to the same ejection destination at timings different from each other. The partition sheet R_2 is formed between jobs that cause the product R_1 to be generated. Therefore, the partition sheet R_2 can be cut out in the same CD cutting process as a CD cutting process of the products R_1, and the processing is not switched to a separate process dedicated to the partition sheet R_2. In addition, the partition sheet R_2 is formed between jobs, and therefore the products R_1 can be divided for each of the jobs. Accordingly, the productivity of the products R_1 can be maintained while the products R_1 of a plurality of jobs can be avoided from being mixed.

The image forming system 1 according to the present disclosure has been described above on the basis of the embodiments, but the present disclosure is not limited to the embodiments, and changes may be made without departing from the scope of the present disclosure. For example, in the embodiments of the present disclosure, an example in which the image forming system 1 includes the image forming apparatus 2 and the post-processing apparatus 3 has been described, but the present disclosure is not particularly limited to this. For example, the image forming system 1 may include a paper feeder, an image reader, a relay apparatus, or the like. In addition, in the embodiments of the present disclosure, comparison is made using the number of times of CD cutting as a configuration that determines whether a final product R_1 of a job has been reached, but the present disclosure is not particularly limited to this. Whether the final product R_1 of a job has been reached may be determined by counting the number of products R_1 that have passed by using the detection sensor 73A and comparing the number of products R_1 with the number of products R_1 to be formed of the job that is obtained from job information. Furthermore, in forming the product R_1, a job that does not form a partition sheet R_2 may be mixed. For example, in a first job that corresponds to a product R_1 that is stacked at the bottom on an ejection destination such as the card tray 74 or the purge tray 75, products R_1 of jobs can be reliably separated from each other by inserting a partition sheet R_2 between the first job and the next job, namely, by inserting a partition sheet R_2 of a second job between the first job and the second job. Therefore, a partition sheet R_2 of the first job may be omitted. Stated another way, the partition sheet R_2 may be present in order to identify a separation position between jobs, and the partition sheet R_2 does not need to be stacked for each of the jobs.

In some embodiments, as illustrated in FIG. 1 and FIG. 2, the controller 200 is included that causes the cutter 71 to cut out a product R_1 formed in part of a paper sheet P and a partition sheet R_2 formed in another part of the paper sheet P. In some embodiments, as illustrated in FIG. 1. FIG. 2, and FIG. 11, in addition to the controller 200 that causes the cutter 71 to cut out a product R_1 formed in part of a paper sheet P and a partition sheet R_2 formed in another part of the paper sheet P, the image former 40 is included that forms an image of the product R_1 in part of a paper sheet P and that forms the partition sheet R_2 in another part of the paper sheet P. In some embodiments, as illustrated in FIG. 1, FIG. 2, and FIG. 11, the controller 200 and the image former 40 are included. The controller 200 causes the cutter 71 to cut out a product R_1 formed in part of a paper sheet P and a partition sheet R_2 formed in another part of the paper sheet P. The image former 40 forms an image of the product R_1 in part of a paper sheet P and forms the partition sheet R_2 in another part of the paper sheet P. Further, in a case where a plurality of jobs that cause the image of the product R_1 to be formed are continuously processed, the image former 40 forms the partition sheet R_2.

In some embodiments, as illustrated in FIG. 1, FIG. 2, and FIG. 11, the controller 200 and the image former 40 are included. The controller 200 causes the cutter 71 to cut out a product R_1 formed in part of a paper sheet P and a partition sheet R_2 formed in another part of the paper sheet P. The image former 40 forms an image of the product R_1 in part of a paper sheet P and forms the partition sheet R_2 in another part of the paper sheet P. Further, in a case where a plurality of jobs that cause the image of the product R_1 to be formed are continuously processed, the image former 40 forms the partition sheet R_2, and imposes the partition sheet R_2 in a position of a division between jobs that cause the image of the product R_1 to be formed.

In some embodiments, as illustrated in FIG. 1, FIG. 2, and FIG. 11, the controller 200 and the image former 40 are included. The controller 200 causes the cutter 71 to cut out a product R_1 formed in part of a paper sheet P and a partition sheet R_2 formed in another part of the paper sheet P. The image former 40 forms an image of the product R_1 in part of a paper sheet P and forms the partition sheet R_2 in another part of the paper sheet P. Further, in a case where a plurality of jobs that cause the image of the product R_1 to be formed are continuously processed, the image former 40 forms the partition sheet R_2, imposes the partition sheet R_2 in a position of a division between jobs that cause the image of the product R_1 to be formed, and imposes a position in which the image of the product R_1 will be formed in accordance with a position in which the partition sheet R_2 will be imposed.

In some embodiments, as illustrated in FIG. 1. FIG. 2. FIGS. 4A to 4H, and FIG. 8 to FIGS. 10A and 10B, the controller 200 is included that causes the cutter 71 to cut out a product R_1 formed in part of a paper sheet P and a partition sheet R_2 formed in another part of the paper sheet P. In a case where the controller 200 causes either the partition sheet R_2 or the product R_1 to be ejected, the controller 200 causes the partition sheet R_2 or the product R_1 to be slacked in such a way that a front-end side of the partition sheet R_2 is aligned with a front-end side of the product R_1.

In the exemplary embodiment illustrated in FIG. 11, the controller 200 and the image former 40 are included. The controller 200 causes the cutter 71 to cut out a product R_1 formed in part of a paper sheet P and a partition sheet R_2 formed in another part of the paper sheet P. The image former 40 forms an image of the product R_1 in part of a paper sheet P and forms the partition sheet R_2 in another part of the paper sheet P. Further, in a case where a plurality of jobs that cause the image of the product R_1 to be formed are continuously processed, the image former 40 forms the partition sheet R_2, imposes the partition sheet R_2 in a position of a division between jobs that cause the image of the product R_1 to be formed, and imposes a position in which the image of the product R_1 will be formed in accordance with a position in which the partition sheet R_2 will be imposed. In a case where the partition sheet R_2 is made plain, the image former 40 secures a range in which the partition sheet R_2 will be formed in accordance with the size of the partition sheet R_2.

In some embodiments, as illustrated in FIG. 1 to FIG. 6 and FIG. 8 to FIGS. 10A and 10B, the controller 200 is included that causes the cutter 71 to cut out a product R_1 formed in part of a paper sheet P and a partition sheet R_2 formed in another part of the paper sheet P. In a case where the controller 200 causes either the partition sheet R_2 or the product R_1 to be ejected, the controller 200 causes the partition sheet R_2 or the product R_1 to be slacked in such a way that a front-end side of the partition sheet R_2 is aligned with a front-end side of the product R_1. The partition sheet R_2 has a length in a direction orthogonal to a conveyance direction of the paper sheet P that is equal to a length of the product R_1, and has a length in the conveyance direction of the paper sheet P that is longer than a length of the paper sheet R_1. Further, the partition sheet R_2 is formed in a color that is different for each job that causes the product R_1 to be generated.

In some embodiments, as illustrated in FIG. 1 to FIG. 6 and FIG. 8 to FIGS. 10A and 10B, the controller 200 is included that causes the cutter 71 to cut out a product R_1 formed in part of a paper sheet P and a partition sheet R_2 formed in another part of the paper sheet P. In a case where the controller 200 causes either the partition sheet R_2 or the product R_1 to be ejected, the controller 200 causes the partition sheet R_2 or the product R_1 to be stacked in such a way that a front-end side of the partition sheet R_2 is aligned with a front-end side of the product R_1. The partition sheet R_2 has a length in a direction orthogonal to a conveyance direction of the paper sheet P that is equal to a length of the product R_1, and has a length in the conveyance direction of the paper sheet P that is longer than a length of the paper sheet R_1. Further, an image that is different from an image of the product R_1 is formed on the partition sheet R_2.

In some embodiments, as illustrated in FIG. 1 to FIG. 6 and FIG. 8 to FIGS. 10A and 10B, the controller 200 is included that causes the cutter 71 to cut out a product R_1 formed in part of a paper sheet P and a partition sheet R_2 formed in another part of the paper sheet P. In a case where the controller 200 causes either the partition sheet R_2 or the product R_1 to be ejected, the controller 200 causes the partition sheet R_2 or the product R_1 to be stacked in such a way that a front-end side of the partition sheet R_2 is aligned with a front-end side of the product R_1. The partition sheet R_2 has a length in a direction orthogonal to a conveyance direction of the paper sheet P that is equal to a length of the product R_1, and has a length in the conveyance direction of the paper sheet P that is longer than a length of the paper sheet R_1. Further, processing that is different from processing performed on the product R_1 is performed on the partition sheet R_2.

In some embodiments, as illustrated in FIG. 1 to FIG. 6 and FIG. 8 to FIGS. 10A and 10B, the controller 200 is included that causes the cutter 71 to cut out a product R_1 formed in part of a paper sheet P and a partition sheet R_2 formed in another part of the paper sheet P. In a case where the controller 200 causes either the partition sheet R_2 or the product R_1 to be ejected, the controller 200 causes the partition sheet R_2 or the product R_1 to be stacked in such a way that a front-end side of the partition sheet R_2 is aligned with a front-end side of the product R_1. On a rear-end side of the partition sheet R_2, at least one of an index that uniquely specifies a job that causes the product R_1 to be generated, the name of the job that causes the product R_1 to be generated, and the processing content of the job that causes the product R_1 to be generated is formed. Further, the partition sheet R_2 is formed in a color that is different for each of the jobs that cause the product R_1 to be generated.

In some embodiments, as illustrated in FIG. 1 to FIG. 6 and FIG. 8 to FIGS. 10A and 10B, the controller 200 is included that causes the cutter 71 to cut out a product R_1 formed in part of a paper sheet P and a partition sheet R_2 formed in another part of the paper sheet P. In a case where the controller 200 causes either the partition sheet R_2 or the product R_1 to be ejected, the controller 200 causes the partition sheet R_2 or the product R_1 to be stacked in such a way that a front-end side of the partition sheet R_2 is aligned with a front-end side of the product R_1. On a rear-end side of the partition sheet R_2, at least one of an index that uniquely specifies a job that causes the product R_1 to be generated, the name of the job that causes the product R_1 to be generated, and the processing content of the job that causes the product R_1 to be generated is formed. Further, an image that is different from an image of the product R_1 is formed on the partition sheet R_2.

In some embodiments, as illustrated in FIG. 1 to FIG. 6 and FIG. 8 to FIGS. 10A and 10B, the controller 200 is included that causes the cutter 71 to cut out a product R_1 formed in part of a paper sheet P and a partition sheet R_2 formed in another part of the paper sheet P. In a case where the controller 200 causes either the partition sheet R_2 or the product R_1 to be ejected, the controller 200 causes the partition sheet R_2 or the product R_1 to be stacked in such a way that a front-end side of the partition sheet R_2 is aligned with a front-end side of the product R_1. On a rear-end side of the partition sheet R_2, at least one of an index that uniquely specifies a job that causes the product R_1 to be generated, the name of the job that causes the product R_1 to be generated, and the processing content of the job that causes the product R_1 to be generated is formed. Further, processing that is different from processing performed on the product_1 is performed on the partition sheet R_2.

Although embodiments of the present invention have been described and illustrated in detail the disclosed embodiments are made for purposes of illustration and example only and not limitation. The scope of the present invention should be interpreted by terms of the appended claims.

What is claimed is:

1. A post-processing apparatus comprising:
a cutter that cuts a paper sheet into a plurality of pieces; and
a hardware processor that causes the cutter to cut out a product formed in part of the paper sheet and a partition sheet formed in another part of the paper sheet, wherein
the hardware processor causes the partition sheet and the product to be ejected to the same ejection destination at timings different from each other, and
the partition sheet is formed between jobs that cause the product to be generated.

2. The post-processing apparatus according to claim 1, wherein
in a case where a size of the partition sheet is different from a size of the product and the partition sheet is cut out in a direction orthogonal to a conveyance direction of the paper sheet, the hardware processor matches a conveyance timing of the paper sheet with a cutting timing of the partition sheet.

3. The post-processing apparatus according to claim 1, wherein
the partition sheet has a length in a direction orthogonal to a conveyance direction of the paper sheet that is equal to a length of the product, and has a length in the conveyance direction of the paper sheet that is longer than a length of the product.

4. The post-processing apparatus according to claim 2, wherein
in a case where the hardware processor causes either the partition sheet or the product to be ejected, the hardware processor causes the partition sheet or the product to be stacked in such a way that a front-end side of the partition sheet is aligned with a front-end side of the product.

5. The post-processing apparatus according to claim 4, wherein
an index that uniquely specifies a job that causes the product to be generated is formed on a rear-end side of the partition sheet.

6. The post-processing apparatus according to claim 4, wherein
a name of a job that causes the product to be generated is formed on a rear-end side of the partition sheet.

7. The post-processing apparatus according to claim 4, wherein
a processing content of a job that causes the product to be generated is formed on a rear-end side of the partition sheet.

8. The post-processing apparatus according to claim 1, wherein
the partition sheet is formed in a color that is different for each job that causes the product to be generated.

9. The post-processing apparatus according to claim 1, wherein
an image that is different from an image of the product is formed on the partition sheet.

10. The post-processing apparatus according to claim 1, wherein
processing that is different from processing performed on the product is performed on the partition sheet.

11. The post-processing apparatus according to claim 10, wherein
as the processing that is different from the processing performed on the product, creasing is performed on the partition sheet.

12. The post-processing apparatus according to claim 10, wherein
as the processing that is different from the processing performed on the product, perforations are formed in the partition sheet.

13. The post-processing apparatus according to claim 1, wherein
the cutter is arranged on a rear-sage side of an image forming apparatus that forms the product and the partition sheet.

14. An image forming apparatus comprising
an image former that forms an image of a product in part of a paper sheet and forms a partition sheet in another part of the paper sheet, wherein
in a case where the partition sheet is made plain, the image former secures a range in which the partition sheet will be formed in accordance with a size of the partition sheet, and
the partition sheet is formed between jobs that cause the product to be generated.

15. The image forming apparatus according to claim 14, wherein
the image former imposes a position in which the image of the product will be formed in accordance with a position in which the partition sheet will be imposed.

16. The image forming apparatus according to claim 14, wherein
the image former determines a position of a division between jobs that cause the image of the product to be formed as a position in which the partition sheet will be imposed.

17. The image forming apparatus according to claim 14, wherein
in a case where a plurality of jobs that cause the image of the product to be formed are continuously processed, the image former forms the partition sheet.

18. An image forming system comprising:
an image former that forms an image of a product in part of a paper sheet and forms a partition sheet in another part of the paper sheet;
a cutter that cuts the paper sheet into a plurality of pieces; and
a hardware processor that causes the cutter to cut out the product and the partition sheet, wherein
the hardware processor causes the partition sheet and the product to be ejected to the same ejection destination at timings different from each other, and
the partition sheet is formed between jobs that cause the product to be generated.
